(19) United States
(12) Patent Application Publication
(10) Pub. No.: US 2026/0178352 A1
(43) Pub. Date: Jun. 25, 2026

(54) DYNAMIC INTRA-SCREEN USER INTERFACE ADAPTATION

(71) Applicant: Capital One Services, LLC, McLean, VA (US)

(72) Inventors: Harvinder SINGH, Woodbridge, VA (US); Robert COWELL, Baltimore, MD (US); Sathiyamurthy THIRUVENGADATHAN, Glen Allen, VA (US)

(21) Appl. No.: 18/999,563

(22) Filed: Dec. 23, 2024

(51) Int. Cl. G06F 9/451; G06F 16/9535; G06F 16/957; H04L 67/306

(52) U.S. Cl. CPC G06F 9/451; G06F 16/9535; G06F 16/9577; H04L 67/306

(57) ABSTRACT

In some implementations, a system may receive a request for a web page from a client device. The system may obtain user context data associated with a user profile, wherein the user profile is associated with the request for the web page. The system may obtain a set of user interface elements associated with the web page based on the user context data and the request for the web page. The system may obtain decision information defining one or more conditions for providing the user interface elements to the client device, wherein the decision information is obtained based on the request for the web page and the user context data. The system may select one or more user interface elements from the set of user interface elements based on the decision information. The system may provide the set of user interface elements to the client device.

### BACKGROUND

User interfaces are software platforms that facilitate communication and interactions with a system, application, and/or website. User interfaces may enable communications between a user and a system, application, and/or website, such as via a self-service user interface, and/or may enable communication among multiple users. For example, a first user (e.g., a collaborator) may interact with a user interface to access user data, procedures, and other information to assist with events or incidents related to a second user. Similarly, a user may interact with a self-service user interface platform to resolve an issue, obtain information, or otherwise transmit communications.

### SUMMARY

In some implementations, a system for dynamic intra-screen user interface adaptation includes one or more memories; and one or more processors, communicatively coupled to the one or more memories, configured to: receive a request for a web page from a client device; obtain user context data associated with a user profile, wherein the user profile is associated with the request for the web page; obtain a set of user interface elements associated with the web page based on the user context data and the request for the web page, wherein the set of user interface elements includes a set of input elements that are obtained based on the user context data and the request for the web page; obtain decision information defining one or more conditions for providing the user interface elements to the client device, wherein the decision information is obtained based on the request for the web page and the user context data; select one or more user interface elements from the set of user interface elements based on the decision information, wherein the one or more selected user interface elements include one or more input elements of the set of input elements; and provide the set of user interface elements including the input elements to the client device.

In some implementations, a method for dynamic intra-screen user interface adaptation includes receiving, by a system, a request for a web page from a client device; obtaining, by the system, user context data associated with a user profile, wherein the user profile is associated with the request for the web page; obtaining, by the system, a set of user interface elements associated with the web page based on the user context data and the request for the web page; obtaining, by the system, decision information defining one or more conditions for providing the user interface elements to the client device, wherein the decision information is obtained based on the request for the web page and the user context data; selecting, by the system, one or more user interface elements from the set of user interface elements based on the decision information; and providing, by the system, the set of user interface elements to the client device.

In some implementations, a non-transitory computer-readable medium storing a set of instructions includes one or more instructions that, when executed by one or more processors of a system, cause the system to: receive a request for a web page from a client device; obtain user context data associated with a user profile, wherein the user profile is associated with the request for the web page, and wherein the client device is associated with a first user, and the user context data and the user profile are associated with a second user; obtain a set of user interface elements associated with the web page based on the user context data and the request for the web page, wherein the set of user interface elements includes a set of input elements that are obtained based on the user context data and the request for the web page; obtain decision information defining one or more conditions for providing the user interface elements to the client device, wherein the decision information is obtained via an application programming interface based on the request for the web page and the user context data; select one or more user interface elements from the set of user interface elements based on the decision information, wherein the one or more selected user interface elements include one or more input elements of the set of input elements; and provide the set of user interface elements including the input elements to the client device, wherein each user interface element in the set of user interface elements is provided to the client device according to an order in which each user interface element is selected for the set of user interface elements.

### BRIEF DESCRIPTION OF THE DRAWINGS

FIG. 1 is a diagram of an example associated with dynamic intra-screen user interface adaptation, in accordance with some embodiments of the present disclosure.

FIGS. 2A-2B are diagrams of an example associated with dynamic intra-screen user interface adaptation, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with dynamic intra-screen user interface adaptation, in accordance with some embodiments of the present disclosure.

FIG. 5 is a flowchart of an example process associated with dynamic intra-screen user interface adaptation, in accordance with some embodiments of the present disclosure.

### DETAILED DESCRIPTION

The following detailed description of example implementations refers to the accompanying drawings. The same reference numbers in different drawings may identify the same or similar elements.

A user interface of a user device, such as a user interface provided by a web browser, may include a web page for presentation via the user device. The web page may include hyperlinks to various other web pages in one or more navigational menus. For example, the user interface of the web page may include visual elements, controls, and/or feedback mechanisms. Additionally, the user interface of a web page may include elements that enable interaction with the website and/or the underlying software and hardware. In some cases, a user may have difficulty locating particular information of interest using a navigational menu. For example, descriptions of the navigational menu may be unintuitive and/or the user may need to click through navigational menus in multiple hierarchical levels in order to locate the information of interest. As a result, poor user interfaces in a variety of settings (e.g., web pages, mobile device applications, software applications, or the like) may result in numerous problems for the user and for the provider of the user interface. For example, navigating through a large number of web pages to find relevant information creates a poor user experience, consumes excessive computing resources (e.g., processing resources and memory resources) that are needed for the user device to generate and display the web pages and that are needed for one or more server devices to serve the web pages to the user device, and consumes excessive network resources that are needed for communications between the user device and the server device. For example, this poor user experience may lead to the user abandoning the web page, potentially wasting the resources that were used to serve the user up to the point of abandonment.

For example, in a collaboration use case, a first user may utilize a user interface (e.g., a web-based or application-based user interface) to access data and information concerning a second user (e.g., information concerning potentially fraudulent or suspicious charges associated with a user account). When a user communicates with an entity (e.g., a financial or other institution), the user may communicate with a collaborator (e.g., via telephone, videoconference, web-based or application-based chat platform, or the like) or may interact directly with a user interface (e.g., a web-based or application-based user interface) to resolve an issue or an inquiry. Where a user communicates with a collaborator, the collaborator may utilize a user interface (e.g., a web-based or application-based user interface) to access data and information concerning the user.

In some cases, an entity may develop and provide a communication workflow that is designed to provide users with a user interface experience that is customized to the user. For example, an intake workflow may include, or may be based on, an incident, report, dispute, or the like. An incident, report, or dispute may relate to an event such as a disputed or incorrect credit card charge, suspicious or fraudulent credit card usage, or a credit card charge flagged as one or more of these.

Classifying a particular intake communication poses various challenges, where various entry points into an intake workflow may not clearly and/or accurately address the issue or incident for which the user has initiated communication. For example, an initial request to report a potential incident may arise because the user does not recognize or understand a credit card charge, because the user has a problem with the goods and/or services associated with the credit card charge and does not want to pay, and/or because the credit card issuer notified the user to indicate that there is a potential problem with the associated credit card account. As a result of the various options, a user interface may provide a static hierarchical user interface workflow that may be unable to address the unique user issue or incident. Furthermore, entities increasingly provide various channels that allow users to access their accounts and initiate intake workflows, including mobile applications, websites, web pages, and telephone call centers, among other examples. Additionally, where a collaborator interacts with an intake workflow, entities may provide various channels that allow the collaborators to access user accounts and initiate intake workflows, including websites, web pages, mobile and/or desktop applications, software that may be specific to certain departments within an entity or specific to certain geographic regions associated with an entity, and/or software that may be specific to third-party collaborators, among other examples. Accordingly, customization for user interfaces (e.g., for initial intake workflows or the like) has traditionally been implemented on a channel-by-channel basis, with each communication having separate microservices or workflow logic (e.g., intake workflows that are designed for mobile applications may have separate user interfaces and logic than intake workflows that are designed for web browsers).

Additionally, user interfaces may pose challenges where the user interface workflow utilizes a static and/or linear web page (e.g., screen) sequence or hierarchy, where each successive web page may display information and/or formatting in response to input on a previous web page. Furthermore, the user interface workflow and the associated web page sequences may include arbitrary and/or linear workflows that do not accurately adapt to subsequent user input and/or user responses. These user interface workflows may also be unique to the associated channel, hardcoded, and therefore not portable to other channels, and/or difficult to update and/or maintain. For example, arbitrary and/or linear workflows and workflows unique to the associated channel may rely on integration with existing user data repositories and associated software, which may limit the frequency and agility of updating user interfaces and the associated user interface workflow. Additionally, developing customized user interface workflows and the associated user interfaces that are specific for a particular channel and/or are capable of addressing a variety of user intake inquiries may result in decreased flexibility and/or control (e.g., developers need to maintain entire intake workflows rather than individual screen sequences or user interfaces, there is no opportunity for updating user interfaces and associated elements mid-flow, and/or there are limited capabilities to monitor and respond to interactions that occur during an intake workflow).

Some implementations described herein enable efficient intra-screen navigation in a user interface. In some implementations, a system may provide dynamic intra-screen user interface adaptation, which may be used to provide user interface elements to a device. For example, in some implementations, the system may receive a request for a web page, obtain user context data associated with a user, obtain a set of user interface elements, and select user interface elements for display based on decision information. Furthermore, the system may enable a user to manage navigation within a single screen (e.g., a web page), where the screen may dynamically display, remove, and/or update user interface elements based on data from application programming interfaces (APIs), user input and interactions, decision rules, or the like. Additionally, the system may obtain user context data including historical information associated with a user and/or historical information associated with a user account to utilize in decisions for dynamically selecting, providing, and updating the user interface elements. Furthermore, the user interface elements may be provided to the client device in an order in which each user interface element is selected. Additionally, the system may select updated, additional, or different user interface elements to provide to the client device based on one or more threshold conditions (e.g., a time period) being satisfied.

As a result, a user interface may be customized and dynamically adapted based on real-time interaction and communication with the user interface. In this way, computing resources and/or network resources may be conserved by reducing an amount of navigation performed by the user. For example, multiple screen transitions may cause higher processor and memory usage on backend servers as concurrent requests to load new screens are processed in response to user interface interactions. Similarly, multiple screen transitions may lead to a higher number of API calls, where each screen change may require separate requests to the backend (e.g., validating input, fetching new screen content and formatting, loading data for each step, or the like). In contrast, by utilizing dynamic intra-screen adaptation, a relatively fewer number of API calls may be performed, where such API calls may only be performed for discrete user interface elements that are to be updated. Additionally, the intra-screen user interface decisioning may enable the frontend of the system to receive rules to select user interface elements to be displayed at a client device based on the API data and/or user input. As the user interacts with the user interface, the system may continuously evaluate the selected user interface and elements thereof based on the rules. As a result, one or more backend elements may provide the rules for displaying the user interface elements, where the content of the user interface elements may be managed by one or more frontend elements.

Furthermore, some implementations described herein make data easier to access by enhancing a user interface, thereby improving a user experience, enhancing user-friendliness of the user interface, and improving the ability of a user to use the user device. For example, some implementations described herein may enable a user to manage navigation within a single screen, thereby simplifying the user interface and providing a more efficient user experience where the single screen interface may be modified and/or updated depending on user interaction and other data and rules. For example, in a user interface that includes a static and/or linear decision flow, a user may be unable to resolve their issue because the user interface is unable to dynamically adapt to user input that may be excluded from or incompatible with the decision flow. For example, where a user has a unique incident or issue that is not addressed by the static and/or linear decision flow, the user interface may be unable to adapt to address the user inputs. In contrast, in an intra-screen user interface that may dynamically update based on interactions, the user interface may be updated based on independent decisioning conditions that adapt the user interface to user inputs. For example, where a user provides an input that contradicts a previous input, the user input elements may be dynamically updated to elicit user responses to resolve the inconsistency.

Additionally, some implementations described herein may enable a centralized user interface logic to provide a consistent user experience across different interaction channels (e.g., web-based, application-based, or the like). For example, by enabling intra-screen dynamic updating, a server and/or a content server may provide user interface elements to update a single screen independent of the channel. In contrast, a user interface that is updated over multiple screens may require the server to provide additional data and information (e.g., fetching new screen content, formatting, configuration, and the like) that is unique to each channel, and as a result, incompatible with different channels.

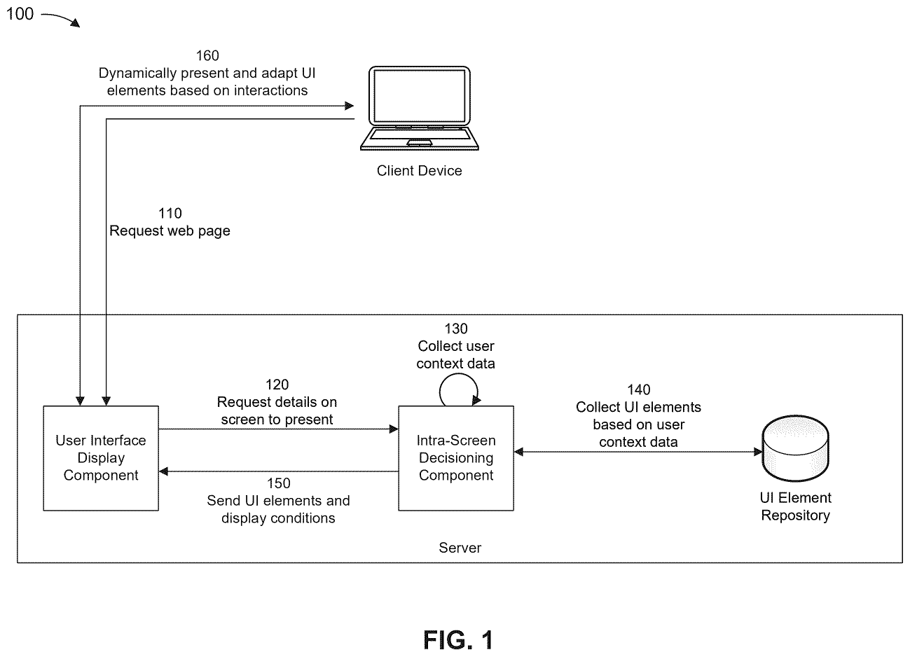

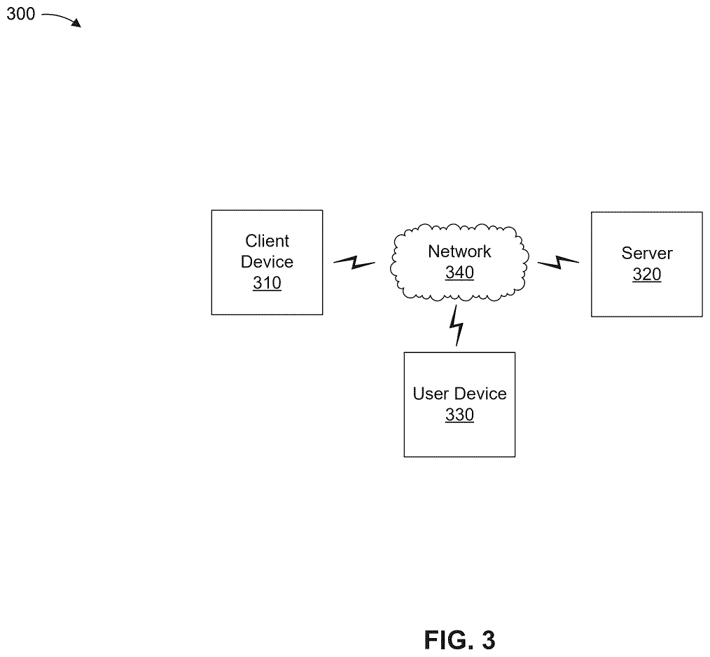

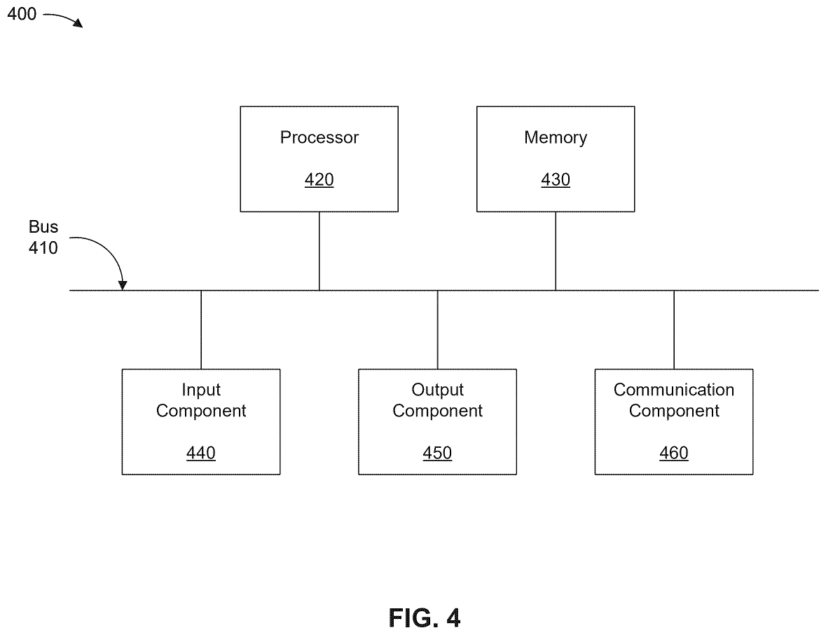

FIG. 1 is a diagram of an example 100 associated with dynamic intra-screen user interface adaptation. As shown in FIG. 1, example 100 includes a client device and a server. These devices are described in more detail in connection with FIGS. 3 and 4.

As shown in FIG. 1, and by reference number 110, the client device may initiate, and a user interface display component of a server may receive, a request for a web page. For example, the request for a web page may be associated with a request for information associated with a user account, including information associated with an inquiry and/or dispute concerning a credit card charge or similar incident. For example, as described herein, the client device may be operated by a collaborator having access to user account information and/or by a user that holds a user account, which may be accessed via one or more communication channels. For example, in some implementations, the client device may request the web page via a mobile application, a web browser, an interactive chat and/or chatbot system, or another suitable channel. In some implementations, the client device may be associated with a user interface (e.g., in a mobile application) used to initiate the request for the web page. Additionally, or alternatively, the server and/or an additional server associated with a user account may actively monitor events associated with the user account to detect potentially unauthorized or suspicious activity and/or other urgent user account information (e.g., upcoming account expiration or the like), in which case one or more notifications may be sent to a collaborator to prompt the collaborator to take action (e.g., assess whether the user account is eligible for renewal). For example, the one or more notifications may include mobile notifications, email messages, text messages, phone calls, or the like. Accordingly, the collaborator may be associated with the client device and may initiate the web page request. Additionally, or alternatively, a user may be associated with a user device and may communicate with a collaborator, where the collaborator may be associated with the client device and may utilize the client device to access a user account in association with a user inquiry. Additionally, or alternatively, the collaborator may utilize the client device to access a user account independently of communication with the user (e.g., where a collaborator is notified of potentially fraudulent or suspicious activity for investigation).

Additionally, or alternatively, the client device may be operated by a user associated with a user account. For example, the user may utilize the client device to transmit a request for a web page associated with a request for user information associated with the user account, including information associated with an inquiry and/or dispute concerning a credit card charge or similar incident. Additionally, or alternatively, the server and/or an additional server associated with a user account may actively monitor events associated with the user account to detect potentially unauthorized or suspicious activity and/or other urgent user account information (e.g., potentially suspicious and/or fraudulent account activity or the like), in which case one or more notifications may be sent to the user to prompt the user to take action (e.g., verify or reject the potentially suspicious and/or fraudulent account activity).

As further shown in FIG. 1, and by reference number 120, the user interface display component may initiate, and an intra-screen decisioning component may receive, a request for details on the appropriate screen to present to the client device. For example, the user interface display component may request a screen and/or web page that is a candidate for presentation to the client device. Additionally, the user interface display component may request user interface elements to be presented to the client device for inclusion in the screen and/or web page. For example, the request for details on the appropriate screen to present to the client device may include information associated with a user account, the client device, a user device, or the like and may include input (e.g., responses to intake queries, communications between a client device and a user device, or the like) associated with the web page request received from the client device.

As further shown in FIG. 1, and by reference number 130, the intra-screen decisioning component may collect user context data. For example, in some implementations, the user context data may include data associated with a user (e.g., an account holder), including a user profile, user account information, information input and/or provided to the client device, or the like. Additionally, or alternatively, the user context data may include information associated with a history of interactions between the user and the website, between the user and the server and/or additional servers associated with the user, or the like. For example, the user context data may include information and/or data associated with the user, including internet protocol (IP) address, cookie data, tracking pixel data, fingerprinting data (e.g., operating system, screen size, browser settings, time zone, or the like), cross-site tracking data, entity tags, supercookies, saved user preferences, or the like. Additionally, or alternatively, the intra-screen decisioning component may utilize an API to access information associated with the user, the user account associated with the user, and/or with the request for the web page received from the client device. In some implementations, the intra-screen decisioning component may evaluate whether additional information (e.g., user context data) may be needed in order to select and provide user interface elements to the client device. For example, in some implementations, the intra-screen decisioning component may include a rules engine to determine whether the user context data includes data associated with one or more categories that are used to select and provide user interface elements for the client device. For example, where the intra-screen decisioning component determines that additional information may be obtained to select and provide user interface elements to the user device, the intra-screen decisioning component may perform API calls to obtain information associated with the request for the web page received from the client device, as well as information associated with the user (e.g., user account, historical user interactions, or the like). For example, where a user interface or screen presents an inquiry as to whether the user provided a credit card “In person” or “Via the Internet” for a specific charge and the user responds “I don't know,” the intra-screen decisioning component may perform an API call to determine whether the card entry method for the charge is associated with “In Person” or “Via the Internet” based on a data repository associated with the credit card. Additionally, or alternatively, the user context data may include information associated with the channel by which the request for the web page was received from the client device (e.g., device type, operating system, screen resolution, or the like). By obtaining user context data and determining whether additional information may be obtained in order to select and provide the user interface elements, the system may improve the relevancy of the user input elements relative to the user interaction, thereby reducing the length of each user communication session and reducing the network and/or processing load on the system. For example, where the client device provides limited information associated with a user, the intra-screen decisioning component may obtain additional information associated with the user (e.g., via an API call) to enable the user interface elements to be selected based on a larger dataset associated with the user.

As further shown in FIG. 1, and by reference number 140, the intra-screen decisioning component may collect user interface elements from a user interface element repository based on the user context data and/or additional data. For example, in some implementations, the intra-screen decisioning component may collect a set of user interface elements associated with the web page based on the user context data and the request for the web page. Additionally, the set of user interface elements may include a set of input elements that are obtained based on the user context data and/or the request for the web page. For example, in some implementations, the input elements may enable interaction with the user interface elements at the client device. For example, the input elements may include interactive radio buttons, check boxes, text input boxes, or the like, thereby enabling the user interface elements to include one or more probing questions to dynamically investigate an event associated with a user or a user intent for the web page. For example, the input elements may be designed to investigate variables such as whether the user recognizes a credit card charge, whether a user has contacted a merchant directly, whether a credit card charge was physically provided to a merchant or was provided via the internet and/or telephone, and/or whether the user attempted to cancel the credit card charge, among other examples. Additionally, or alternatively, based on the channel from which the request for the web page was received from the client device (e.g., desktop computer, tablet, mobile phone, or the like), the intra-screen decisioning component may collect user interface elements that are specific to the channel. For example, in a mobile device application, the intra-screen decisioning component may collect user interface elements that are configured for a mobile device screen size and/or enable touchscreen inputs. Additionally, in the context of a desktop-based web browser, the intra-screen decisioning component may collect user interface elements that are configured for a desktop-based web browser sizing and exclude touchscreen input configurations.

As further shown in FIG. 1, and by reference number 150, the intra-screen decisioning component may send, and the user interface display component may receive, the user interface elements and display conditions obtained from the user interface element repository. For example, in some implementations, the intra-screen decisioning component may send a set of user interface elements associated with the user context data, the request for the web page received from the client device, and/or other data to the user interface display component. Additionally, one or more of the user interface elements of the set of user interface elements may include one or more associated input elements that enable interaction with the user interface elements at the client device.

In some implementations, the display conditions may include decision information defining one or more conditions for selecting and providing the user interface elements to the client device. For example, the decision information may be based on the user context data, the request for the web page received from the client device, and/or other data. For example, the decision information may provide conditions for displaying user interface elements based on whether a credit card charge is associated with an “In Person” charge or a charge “Via the Internet.” In some implementations, one or more of the display conditions may be the same and multiple user interface elements may have the same conditions for display. For example, where a user interface element includes a question inquiring whether a credit card was provided to a merchant “Via the Internet” or “In Person,” the user interface display component may provide a user interface element that includes a question inquiring whether a user would like to continue the interaction or to exit the interaction, regardless of the answer to the previous question.

As further shown in FIG. 1, and by reference number 160, the user interface display component may dynamically present and adapt user interface elements based on interactions with the user interface occurring at the client device.

For example, the client device may provide, and the server may receive, one or more interactions associated with the user interface (e.g., with the input elements), where the one or more interactions may include user input such as responses to questions that are associated with the user interface elements. Based on the interactions received from the client device (e.g., the initial request for a web page and/or subsequent interactions with a user interface), the server may select one or more additional and/or updated user interface elements in accordance with the display conditions. For example, the user interface display component may dynamically present and adapt the user interface elements on an intra-screen basis to provide these additional and/or updated user interface elements in response to the interactions received from the client device. As a result, the user interface display component may respond faster to user input because the user interface elements are already available (e.g., the user interface elements may not need to be re-obtained from user interface element repository). Additionally, or alternatively, the server may obtain updated and/or new decision information based on one or more interactions associated with the user interface. For example, where an interaction indicates that a response to a previous question was incorrect and/or incompatible with the current question, the server may obtain updated and/or new decision information for the selection and presentation of updated and/or new user interface elements. For example, where a response to a question indicates that a credit card was presented to a merchant “In Person,” but a response to a previous question indicated that a credit card was provided to the merchant “Via the Internet,” user interface elements may be selected for presentation according to updated and/or new decision information, including different display conditions for subsequent display of user interface elements. As a result, the system may provide a more efficient workflow that adapts to interactions with the user interface, thereby conserving system resources and providing a more efficient and expedited user experience.

Additionally, or alternatively, the server may be configured to select one or more additional, different, or updated user interface elements to provide to the client device based on a condition being satisfied. For example, where the server has not received an interaction from the client device for a certain time period, the server may provide updated user interface elements to the client device. In such an example, the updated user interface elements may prompt a response from the client device or inquire whether additional assistance is requested. By utilizing a condition, the system may reduce unnecessary resource usage where a client device may be unresponsive or where other conditions are satisfied.

In some implementations, one or more user interface element in the set of user interface elements may be provided to the client device according to an order in which each user interface element is selected for the set of user interface elements. For example, the user input elements received from the intra-screen decisioning component may be included in an array, in which each user input element is evaluated by the display conditions according to the order in which the input elements were received from the intra-screening decisioning component. Where a display condition and/or display condition set is satisfied, the associated user interface element may be added to an ordered list of user interface elements to be presented to the client device. Furthermore, each display condition and/or display condition set may be evaluated with respect to the remaining user interface elements until all user interface elements received from the intra-screen decisioning component have been evaluated. As a result, the client device may be presented with the user interface elements in the ordered list according to the order in which each user interface element appears.

As described herein, some implementations may enable efficient navigation in a user interface, including a dynamic intra-screen user interface adaptation, which may be used to provide user interface elements to a client device. As a result, a user interface may be customized to a user and may be dynamically updated based on interaction and communication with the user interface. In this way, computing resources and/or network resources may be conserved by reducing an amount of navigation performed by the user. Furthermore, the techniques described herein make data easier to access by enhancing a user interface, thereby improving a user experience, enhancing user-friendliness of a user device and the user interface, and improving the ability of a user to use the user device. For example, by selecting user interface elements based on user context data (e.g., a history of user interface interactions associated with a user, historical account information associated with the user, or the like), the system may provide an efficient workflow that is customized to the user. Additionally, the described techniques may enable a centralized user interface logic to provide a consistent user experience across different interaction channels (e.g., web-based, application-based, or the like).

As indicated above, FIG. 1 is provided as an example. Other examples may differ from what is described with regard to FIG. 1.

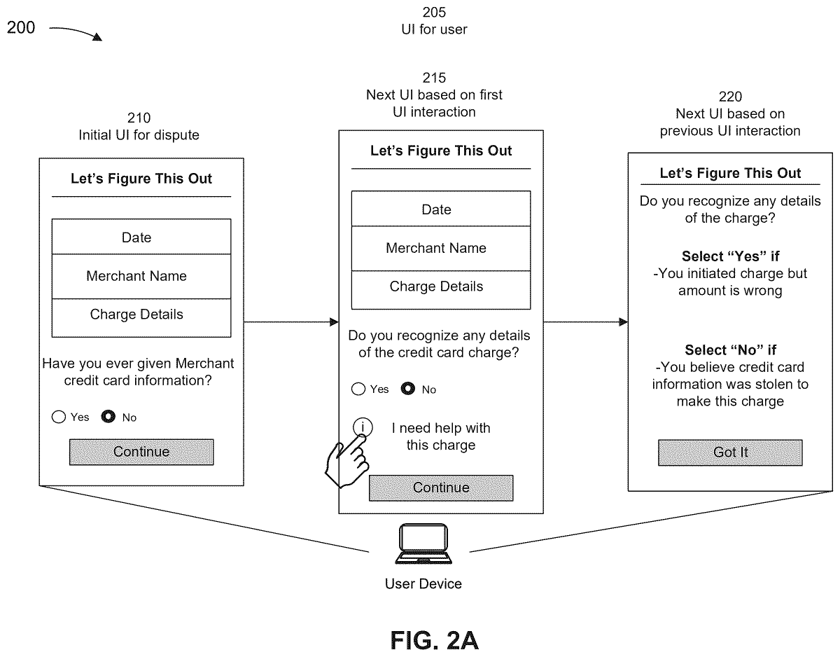

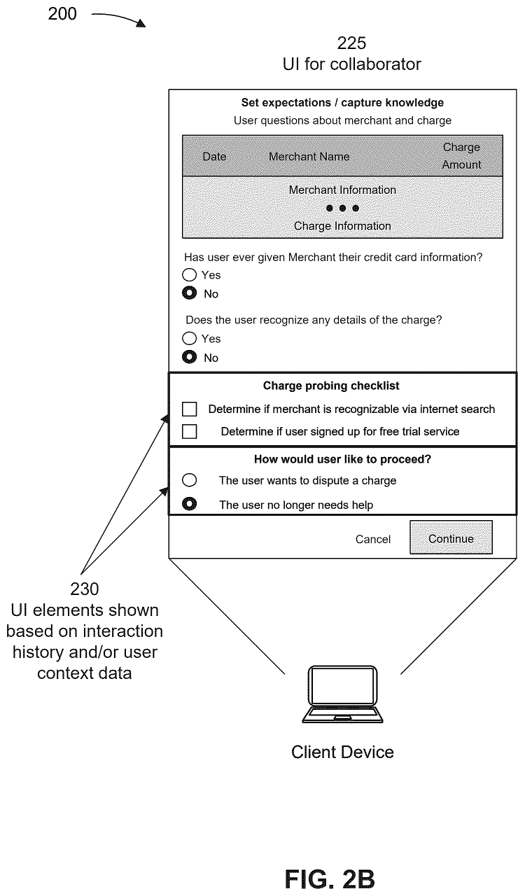

FIGS. 2A-2B are diagrams of an example 200 associated with dynamic intra-screen user interface adaptation. As shown in FIGS. 2A-2B, example 200 includes a user device and a client device. These devices are described in more detail in connection with FIGS. 3 and 4. Additionally, FIGS. 2A-2B are a particular example implementation of FIG. 1 in a customer service and/or collaboration use case.

As shown in FIG. 2A, a set of user interfaces 205 for a user may include user interface elements for initiating a dispute concerning a credit card charge. Additionally, or alternatively, the set of user interfaces 205 may be accessed via a client device, which may be a desktop computer, laptop computer, tablet, mobile phone, or the like. In some implementations, the set of user interfaces 205 may include an initial user interface 210, which may include details concerning a charge for which the user has requested a dispute, including the charge date, merchant name and information, charge amount, charge information, or the like. Additionally, the initial user interface 210 may include one or more questions regarding whether the user has ever provided the specific merchant credit card information associated with the dispute.

In some implementations, following the user submitting a response to the initial user interface 210, the user interface may be dynamically updated to display a next user interface 215 based on the first user interface interaction, including updated user interface elements. As described herein, the user interface elements displayed in the next user interface 215 may include subsequent questions based on user interaction (e.g., user interaction with the initial user interface 210). For example, the next user interface 215 may query whether the user recognizes any details of the credit card charge associated with the dispute. Additionally, the next user interface 215 may include an interactive button enabling a user to request help with the charge. Upon selecting the interactive button, the user interface may dynamically update to provide a user interface indicated by reference number 220 and including updated user interface elements, where the user may be provided with additional instructions for answering questions associated with the dispute. In some implementations, the responses selected for the user interfaces designated as 210 and 215 may be provided to a collaborator and/or to a client device for further usage in connection with the dispute.

For example, as further shown in FIG. 2B, a user interface 225 for collaborator may include user interface elements for accessing and interacting with details related to a dispute for a credit card charge associated with the user. For example, in some implementations, the user interface 225 may be accessed via a client device, which may include a desktop computer, laptop computer, tablet, mobile phone, or the like. The user interface 225 may include details concerning the charge for which the user is initiating a dispute, including the charge date, merchant name and information, charge amount, charge information, or the like. In some implementations, the user interface may include intake questions and corresponding responses concerning the dispute. For example, the responses to the intake questions may be transmitted from the user device and received by the client device. Additionally, or alternatively, the responses to the intake questions may be input into the user interface 225 by the collaborator.

As shown by reference number 230, one or more user interface elements may be displayed on the client device based on interactions with the user interface and/or based on user context data. For example, the client device may be in communication with a server, where the server may provide one or more user interface elements according to decision information, including one or more conditions for providing the user interface elements to the client device. As described herein, where the server receives input from the client device, the server may select one or more updated, additional, or different user interface elements to provide to the client device. For example, where the server receives input associated with the “Charge probing checklist” response options and/or the “How would user like to proceed?” response options, the server may select one or more updated, additional, or different user interface elements to provide to the client device. As described herein, such user interface elements may be selected based on decision information that defines one or more conditions for providing the selected user interface elements to the client device. As a result, the user interface 225 may be dynamically updated on an intra-screen basis to display the selected user interface elements.

As described herein, some implementations may enable efficient navigation in a user interface, including a dynamic intra-screen user interface adaptation, which may be used to provide user interface elements to a client device. As a result, a user interface may be customized and dynamically updated based on context data associated with a user and on interaction with the user interface. As a result, a user interface may be customized to a user and may be dynamically updated based on interaction and communication with the user interface. In this way, computing resources and/or network resources may be conserved by reducing an amount of navigation performed by the user. Furthermore, the techniques described herein make data easier to access by enhancing a user interface, thereby improving a user experience, enhancing user-friendliness of a user device and the user interface, and improving the ability of a user to use the user device. For example, a decisioning process may be applied on an intra-screen basis where user interface elements and input elements may be displayed and dynamically updated on a user interface based on interaction with the user interface, thereby enabling the system to adapt to user interactions. Additionally, the described techniques may enable a centralized user interface logic to provide a consistent user experience across different interaction channels (e.g., web-based, application-based, or the like).

As indicated above, FIGS. 2A-2B are provided as an example. Other examples may differ from what is described with regard to FIGS. 2A-2B.

FIG. 3 is a diagram of an example environment 300 in which systems and/or methods described herein may be implemented. As shown in FIG. 3, environment 300 may include a client device 310, a server 320, a user device 330, and a network 340. Devices of environment 300 may interconnect via wired connections, wireless connections, or a combination of wired and wireless connections.

The client device 310 may include one or more devices capable of receiving, generating, storing, processing, and/or providing information associated with a dynamic intra-screen user interface adaptation, as described elsewhere herein. The client device 310 may include a communication device and/or a computing device. For example, the client device 310 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The server 320 may include one or more devices capable of receiving, generating, storing, processing, providing, and/or routing information associated with dynamic intra-screen user interface adaptation, as described elsewhere herein. The server 320 may include a communication device and/or a computing device. For example, the server 320 may include a server, such as an application server, a client server, a database server, a host server, a proxy server, a virtual server (e.g., executing on computing hardware), a server in a cloud computing system, a web server, or a similar server device. In some implementations, the server 320 may include computing hardware used in a cloud computing environment.

The user device 330 may include one or more devices capable of receiving, generating, storing, processing, and/or providing information associated with dynamic intra-screen user interface adaptation, as described elsewhere herein. The user device 330 may include a communication device and/or a computing device. For example, the user device 330 may include a wireless communication device, a mobile phone, a user equipment, a desktop phone, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with dynamic intra-screen user interface adaptation. The device 400 may correspond to the client device 310, the server 320, and/or the user device 330. In some implementations, the client device 310, the server 320, and/or the user device 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

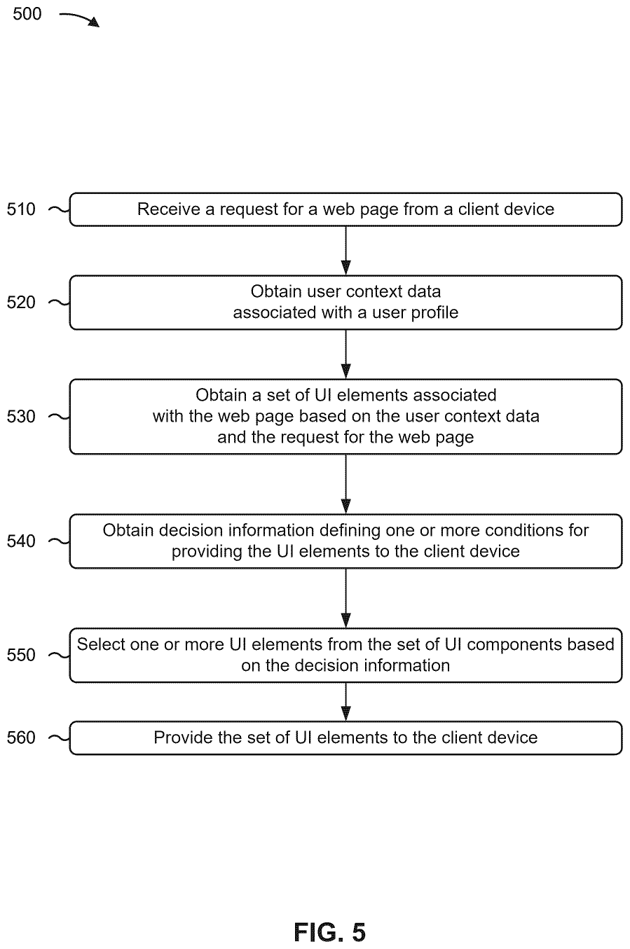

FIG. 5 is a flowchart of an example process 500 associated with dynamic intra-screen user interface adaptation. In some implementations, one or more process blocks of FIG. 5 may be performed by the server 320. In some implementations, one or more process blocks of FIG. 5 may be performed by another device or a group of devices separate from or including the server 320, such as the client device 310 and/or the user device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a request for a web page from a client device (block 510). For example, the server 320 (e.g., using processor 420, memory 430, input component 440, and/or communication component 460) may receive a request for a web page from a client device, as described above in connection with reference number 110 of FIG. 1. As an example, a collaborator may use a client device to request a web page in connection with an investigation of potentially suspicious or fraudulent activity of a credit card associated with a user account.

As further shown in FIG. 5, process 500 may include obtaining user context data associated with a user profile (block 520). For example, the server 320 (e.g., using processor 420 and/or memory 430) may obtain user context data associated with a user profile, as described above in connection with reference number 130 of FIG. 1. As an example, the server 320 may obtain user context data associated with the user account and with the potentially suspicious or fraudulent activity, including historical interactions associated with the user account, related credit card activity associated with the user account, previously reported suspicious or fraudulent activity associated with a merchant, or the like. Similarly, where additional user context data may be needed for determining whether a user interface element meets certain decisioning conditions, the server 320 may obtain this additional user context data via an API call or the like. In some implementations, the user profile may be associated with the request for the web page. As an example, the request for the web page may include information and/or data identifying the associated user profile so that the server may obtain user context data associated with the correct user.

As further shown in FIG. 5, process 500 may include obtaining a set of user interface elements associated with the web page based on the user context data and the request for the web page (block 530). For example, the server 320 (e.g., using processor 420 and/or memory 430) may obtain a set of user interface elements associated with the web page based on the user context data and the request for the web page, as described above in connection with reference number 140 of FIG. 1. As an example, the server 320 may obtain a set of user interface elements from a user interface element repository, where the set of user interface elements may be related to the user account and to the potentially suspicious or fraudulent activity.

As further shown in FIG. 5, process 500 may include obtaining decision information defining one or more conditions for providing the user interface elements to the client device (block 540). For example, the server 320 (e.g., using processor 420 and/or memory 430) may obtain decision information defining one or more conditions for providing the user interface elements to the client device, as described above in connection with reference number 150 of FIG. 1. As an example, where the request for the web page included responses to intake questions indicating that the user is in physical possession of the credit card and that the user does not recognize a specific credit card charge, the conditions for selecting user interface elements to display to the client device may be updated to include only user interface elements that are relevant to these intake question responses. In some implementations, the decision information is obtained based on the request for the web page and the user context data. As an example, where the request for the web page included responses to intake questions indicating the user is unaware of whether a credit card charge was “In Person” or “Via the Internet,” the server may obtain user context data associated with the specific charge associated with the user in order to obtain decision information that is relevant to the response and to the user context data.

As further shown in FIG. 5, process 500 may include selecting one or more user interface elements from the set of user interface elements based on the decision information (block 550). For example, the server 320 (e.g., using processor 420 and/or memory 430) may select one or more user interface elements from the set of user interface elements based on the decision information, as described above in connection with reference number 160 of FIG. 1. As an example, the server 320 may select one or more user interface elements that are relevant to the intake questions and are relevant to the user account associated with the initial request from the client device.

As further shown in FIG. 5, process 500 may include providing the set of user interface elements to the client device (block 560). For example, the server 320 (e.g., using processor 420 and/or memory 430) may provide the set of user interface elements to the client device, as described above in connection with reference number 160 of FIG. 1. As an example, the user interface of the client device may be dynamically updated to include the user interface elements that are relevant to the intake questions and are relevant to the user account associated with the initial request from the client device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 1, FIG. 2A, and/or FIG. 2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic intra-screen user interface (UI) adaptation, the system comprising:
one or more memories; and
one or more processors, communicatively coupled to the one or more memories, configured to:
receive a request for a web page from a client device;
obtain user context data associated with a user profile,
wherein the user profile is associated with the request for the web page;
obtain a set of UI elements associated with the web page based on the user context data and the request for the web page,
wherein the set of UI elements includes a set of input elements that are obtained based on the user context data and the request for the web page;
obtain decision information defining one or more conditions for providing the UI elements to the client device,
wherein the decision information is obtained based on the request for the web page and the user context data;
select one or more UI elements from the set of UI elements based on the decision information,
wherein the one or more selected UI elements include one or more input elements of the set of input elements; and
provide the set of UI elements including the input elements to the client device.

2. The system of claim 1, wherein the one or more processors are further configured to:
receive input information from the client device,
wherein the input information is related to the set of input elements included in the set of UI elements;
select an updated one or more UI elements from the set of UI elements based on the decision information; and
provide the updated one or more UI elements to the client device.

3. The system of claim 1, wherein the one or more processors are further configured to:
receive input information from the client device,
wherein the input information is related to the set of input elements included in the set of UI elements;
obtain updated decision information based on the input information;
select an updated one or more UI elements from the set of UI elements based on one or more of the updated decision information or the decision information; and
provide the updated one or more UI elements to the client device.

4. The system of claim 1, wherein the client device is associated with a first user and the user context data and the user profile are associated with a second user.

5. The system of claim 1, wherein the user context data includes information associated with a history of interactions with the web page associated with the user profile.

6. The system of claim 1, wherein the one or more processors are further configured to:
obtain historical information from one or more repositories associated with the user profile,
wherein the user context data includes the historical information.

7. The system of claim 1, wherein the one or more processors are further configured to:
determine a channel associated with the request for the web page,
wherein the channel is associated with a web browser application or a mobile device application, and
wherein the one or more UI elements provided to the client device are specific to the determined channel.

8. The system of claim 1, wherein each UI elements in the set of UI elements is provided to the client device according to an order in which each UI elements is selected for the set of UI elements.

9. The system of claim 1, wherein the one or more processors are further configured to:
select an updated one or more UI elements from the set of UI elements based on a threshold condition being satisfied; and
provide the updated one or more UI elements to the client device.

10. A method for dynamic intra-screen user interface (UI) adaptation, comprising:
receiving, by a system, a request for a web page from a client device;
obtaining, by the system, user context data associated with a user profile,
wherein the user profile is associated with the request for the web page;
obtaining, by the system, a set of UI elements associated with the web page based on the user context data and the request for the web page;
obtaining, by the system, decision information defining one or more conditions for providing the UI elements to the client device,
wherein the decision information is obtained based on the request for the web page and the user context data;
selecting, by the system, one or more UI elements from the set of UI elements based on the decision information; and
providing, by the system, the set of UI elements to the client device.

11. The method of claim 10, further comprising:
receiving input information from the client device,
wherein the input information is related to the set of UI elements;
obtaining updated decision information based on the input information;
selecting an updated one or more UI elements from the set of UI elements based on one or more of the updated decision information or the decision information; and
providing the updated one or more UI elements to the client device.

12. The method of claim 10, wherein the client device is associated with a first user and the user context data and the user profile are associated with a second user.

13. The method of claim 10, wherein the user context data includes information associated with a history of interactions with the web page associated with the user profile.

14. The method of claim 10, further comprising:
determining a channel associated with the request for the web page,
wherein the channel is associated with a web browser application or a mobile device application, and
wherein the one or more UI elements provided to the client device are specific to the determined channel.

15. A non-transitory computer-readable medium storing a set of instructions, the set of instructions comprising:
one or more instructions that, when executed by one or more processors of a system, cause the system to:
receive a request for a web page from a client device;
obtain user context data associated with a user profile,
wherein the user profile is associated with the request for the web page, and
wherein the client device is associated with a first user, and the user context data and the user profile are associated with a second user;
obtain a set of user interface (UI) elements associated with the web page based on the user context data and the request for the web page,
wherein the set of UI elements includes a set of input elements that are obtained based on the user context data and the request for the web page;
obtain decision information defining one or more conditions for providing the UI elements to the client device,
wherein the decision information is obtained via an application programming interface (API) based on the request for the web page and the user context data;
select one or more UI elements from the set of UI elements based on the decision information,
wherein the one or more selected UI elements include one or more input elements of the set of input elements; and
provide the set of UI elements including the input elements to the client device,
wherein each UI elements in the set of UI elements is provided to the client device according to an order in which each UI elements is selected for the set of UI elements.

16. The non-transitory computer-readable medium of claim 15, wherein the one or more instructions further cause the system to:
receive input information from the client device,
wherein the input information is related to the set of input elements included in the set of UI elements;
obtain updated decision information based on the input information;
select an updated one or more UI elements from the set of UI elements based on one or more of the updated decision information or the decision information; and
provide the updated one or more UI elements to the client device.

17. The non-transitory computer-readable medium of claim 15, wherein the user context data includes information associated with a history of interactions with the web page associated with the user profile.

18. The non-transitory computer-readable medium of claim 15, wherein the one or more instructions further cause the system to:
obtain historical information from one or more repositories associated with the user profile,
wherein the user context data includes the historical information.

19. The non-transitory computer-readable medium of claim 15, wherein the one or more instructions further cause the system to:
determine a channel associated with the request for the web page,
wherein the channel is associated with a web browser application or a mobile device application, and
wherein the one or more UI elements provided to the client device are specific to the determined channel.

20. The non-transitory computer-readable medium of claim 15, wherein the one or more instructions further cause the system to:
select an updated one or more UI elements from the set of UI elements based on a threshold condition being satisfied; and
provide the updated one or more UI elements to the client device.
